(19) United States
(12) Patent Application Publication
(10) Pub. No.: US 2015/0218012 A1
(43) Pub. Date: Aug. 6, 2015

(54) WATER TREATMENT PROCESS COMPRISING FLOATATION COMBINED WITH GRAVITY FILTRATION, AND CORRESPONDING EQUIPMENT

(71) Applicant: VEOLIA WATER SOLUTIONS & TECHNOLOGIES SUPPORT, Saint-Maurice Cedex (FR)

(72) Inventors: Abdelkader Gaid, Paris (FR); Jerome Leparc, Poissy (FR)

(73) Assignee: Veolia Water Solutions & Technologies Support, Saint-Maurice Cedex (FR)

(21) Appl. No.: 14/429,250

(22) PCT Filed: Sep. 13, 2013
(86) PCT No.: PCT/EP2013/069061

§ 371 Date: Mar. 18, 2015

(30) Foreign Application Priority Data
Sep. 19, 2012 (FR) 1258789

(51) Int. Cl. C02F 1/24; B01D 21/00

(52) U.S. Cl. CPC C02F 1/24; B01D 21/0084; C02F 2101/10

(57) ABSTRACT

The invention pertains to a method for treating water in order to make it drinkable or desalinated, said method comprising at least one cycle for treating said water comprising:
a step of coagulation and/or flocculation;
a step of flotation, within a flotation reactor (29), of the water coming from said step of coagulation, followed or not followed by a step of flocculation;
a step of gravity filtration, within a gravity filter (33), of the water coming from said step of flotation, said flotation reactor (29) being at least partly superimposed on said gravity filter (33),
   and at least one cycle for washing said gravity filter comprising a step for backwashing said gravity filter,
   characterized in that said step of gravity filtration is carried out at a speed of 10 m/h to 30 m/h, said gravity filter having a bed of filtering material (330) distributed on a height of 1.5 m to 3.0 m.

This application is a U.S. National Stage Application of PCT Application No. PCT/EP2013/069061, with an international filing date of 13 Sep. 2013. Applicant claims priority based on French Patent Application No. 1258789 filed 19 Sep. 2012. The subject matter of these applications is incorporated herein.

### 1. FIELD OF THE INVENTION

The field of the invention is that of the treatment of water to make it drinkable or to desalinate it.

More specifically, the invention pertains to a technique for treating water that combines flotation and gravity filtering.

### 2. PRIOR ART

Various methods can be implemented to produce drinkable or potable water. These methods, also called methods of potabilization, include the DAFF (Dissolved Air Flotation Filtration) methods which combine flotation and granular filtration.

Referring to FIG. 1, a method of this type comprises successive cycles for treating in which generally water to be treated is introduced into a coagulation tank 10 possibly followed by one or more flocculation tanks 10′, 10″ using an inlet pipe 11. The coagulation and the flocculation can take place in the same tank 10. One or more coagulant reagents 12 with or without a flocculent 13 are injected therein and mixed into the water to be treated. The use of coagulant reagent is therefore obligatory, whereas that of flocculent is optional. Thus, the colloidal particles and particles in suspension in the water to be treated, especially algae phytoplankton, get agglomerated and form flocs. A part of the organic matter dissolved in water can also be adsorbed.

The preliminarily coagulated and, as the case may be also flocculated, water is then conveyed through an overflow element 18 to the base of the injection zone 140 of a flotation reactor 14 where oxygen-supersaturated water 15 is also introduced. Under the effect of the expansion of oxygen within the flotation reactor, gas bubbles are formed and rise to the surface of the flotation reactor 14 driving with them the flocs present in the water. The mixture of air bubbles and flocs is then discharged in an overflow from the separation zones 141 of the flotation reactor 14 through a chute 19 into which it is pushed by means of a scraping device provided for this purpose.

The water that has undergone flotation flows by gravity from the base of the flotation reactor 14, and more particularly the base of its separation zone 141, into a gravity filter 16, which extends in the prolongation of the separation zone 141 of the flotation reactor 14 beneath this separating zone. This gravity filter 16 houses a granular filtering material distributed over a maximum height of material of about 1.20 m. This material can be a single-layer material and be constituted for example by a layer of sand, or a multi-layer material, in particular a two-layer material, constituted for example by a layer of sand and at least one layer of another material such as anthracite, pumice stone, granular activated carbon, etc. The water coming from the flotation reactor 14 is filtered in this gravity filter 16 and thus rid of the flocs and residual particles that are suspended therein. Treated water 17 is collected at the outlet of the gravity filter 16.

As and when the water is filtered within the gravity filter 16, this filter gets clogged. In order to enable a gravity filter 16 to maintain an appropriate level of performance, washing cycles are regularly carried out between two processing cycles. These washing cycles generally consist of the counterflow injection of water through the gravity filter 16 via injection means 15′ to release the matter that collects between the interstices formed between the filtering material grains. This matter rises with the wash water up to the overflow element 19 of the flotation reactor from which it is discharged.

Methods of this kind can also be implemented as methods of pre-treatment in a desalination treatment process, the water coming from the gravity filter 16 being then used as feed water for a desalination unit, for example a reverse osmosis desalination unit.

Methods of this type are particularly efficient because they can be used to produce drinkable water or feed water of high quality for reverse osmosis membranes. However, they can be further improved.

### 3. DRAWBACKS OF THE PRIOR ART

In particular, the granular materials of prior-art systems combining flotation and gravity filtering have heights in the range of 1.20 m. Such heights do not allow filtering speeds of over 10 m/h. However, it is desirable to be able to use higher speeds.

Besides, in order to obtain appropriate liquid-solid separation between the flocs and the water, the height of the water in the flotation reactor 14 must be sufficiently great. It is generally from 3.5 to 5.5 meters.

Given this great height of water, it has been observed that, in existing methods, the water rise time for the wash water injected in a counterflow into the gravity filter is great. For example, when the height of water in the flotation reactor ranges from 4 to 5.5 meters, and when the speed of the wash water in the gravity filter ranges from 20 to 50 m³/m²/h, the wash-water rise time up to the overflow element of the flotation reactor ranges respectively from 12 to 16.6 minutes and 4.8 to 6.6 minutes. By comparison, the wash-water rise time in a conventional sand filter, 1 to 1.2 meters high, would be in the range of 3 minutes during the washing of the filter at 20 m³/m²/h.

A great wash-water rise time in the flotation reactor leaves enough time for the particles of flocs dislodged from the gravity filter to meet one another in the flotation reactor and get aggregated with one another to form larger-sized particles or flocs. This phenomenon, called re-flocculation, thus causes the formation of heavier particles and flocs, which are difficult to discharge from the flotation reactor when the wash water is rising up to its overflow element. These particles and flocs then tend to get decanted at the surface of the gravity filter, i.e. at the interface between the gravity filter and the flotation reactor. Thus, a fine layer of particles and flocs is formed on the surface of the gravity filter. The presence of this fine layer tends to increase the initial head loss through the gravity filter at the end of a washing cycle. This re-flocculation phenomenon therefore lowers the performance of the gravity filter.

According to another aspect, when the water, which has undergone a flotation step and is super-saturated in oxygen, passes through the filtering layer of the gravity filter, it creates a de-gassing of this water, then giving rise to the formation of air bubbles within the filtering material. These air bubbles are most often trapped in the interstices between the grains of filtering material. The presence of these gas bubbles within the filtering material, resulting from this phenomenon, called gas cavitation or bubble formation in the filter, tends to gradually increase the head loss through the filter. It is then necessary to carry out frequent cycles for washing the filter so that it can maintain an appropriate level of performance. Gas cavitation of the filter therefore leads to a reduction in the duration of the processing cycles, an increase in the loss of water due to the washing of the filter and a reduction of the production of treated water.

Besides, the prior-art techniques pre-suppose the use of relatively large-sized installations for coagulation and, as the case may be, flocculation because the treatment times for obtaining efficient coagulation and, as the case may be, efficient flocculation are relatively lengthy, depending on the quality of the water to be treated and the temperature.

### 4. GOALS OF THE INVENTION

The invention is aimed especially at overcoming these drawbacks of the prior art.

More specifically, it is a goal of the invention to provide a technique for treating water combining a flotation and a gravity filtering, the performance of which can, in at least one embodiment, be enhanced as compared with the prior-art treatment techniques of this type.

In particular, it is a goal of the invention, in at least one embodiment, to implement a technique of this kind that makes it possible to implement filtering speeds of over 10 m/h.

It is another goal of the invention, in at least one embodiment, to limit or even eliminate the phenomenon of re-flocculation in the flotation reactor during operations for washing the gravity filter.

It is yet another goal of the invention to implement a technique of this kind that contributes, in at least one embodiment, to limiting or even eliminating the phenomenon of gas cavitation in the gravity filter.

The invention also seeks to provide a technique of this kind, the implementing of which, in at least one embodiment, optimizes the step of coagulation and, as the case may be, flocculation especially by reducing the time of contact of water with the coagulant or coagulants and, possibly, flocculants and by reducing the size of the coagulation and, possibly, flocculation installations.

It is another goal of the invention to provide a technique of this kind which, in at least one embodiment, is simple and/or reliable and/or economical.

### 5. SUMMARY OF THE INVENTION

These goals, as well as others that shall appear here below, are achieved by means of method for treating water in order to make it drinkable or desalinated, said method comprising at least one cycle for treating said water comprising:
a step of coagulation, followed or not followed by a step of flocculation;
a step of flotation, within a flotation reactor, of the water coming from said step of coagulation, followed or not followed by a step of flocculation;
a step of gravity filtration, within a gravity filter, of the water coming from said step of flotation, said flotation reactor being at least partly superimposed on said gravity filter,

and at least one cycle for washing said gravity filter comprising a step for backwashing said gravity filter.

According to the invention, said step of gravity filtration is carried out at a speed of 10 m/h to 30 m/h, said gravity filter having a bed of filtering material distributed on a height of 1.5 m to 3.0 m.

Thus, according to the invention, through the use of greater heights of filtering material, the filtering speed and, as a corollary, the flow rates of treated water can be considerably increased.

Specifically, the flotation reactor is at least partly superimposed on the gravity filter. Preferably, it will not be totally superimposed on the gravity filter.

According to a preferred variant of the invention, said cycle for washing comprises a step for sweeping the interface I between said flotation reactor and said gravity filter with a fluid dispensed by means of a system of injection bars that extend on the surface of said interface I.

Thus, in this preferred variant, the invention relies on a wholly original approach. This wholly original approach, in a method combining a flotation in a flotation reactor and a high-speed filtering in a gravity filter situated in the prolongation of the flotation reactor, consists of the sweeping, during the washing of the filter, of the interface between the flotation reactor and the gravity filter with a fluid dispensed by means of a system of injection bars that extend up to the surface of this interface.

The fact of sweeping the interface between the flotation reactor and the gravity filter, in other words the upper surface of the gravity filter or at least a region close to this place, during the washing of the filter, reduces the time taken by the particles and/or flocs released from the gravity filter to rise up to the overflow element of the flotation reactor and therefore accelerates their removal. Since the rise time of the particles and/or flocs is reduced, the re-flocculation phenomenon is prevented or at the very least reduced.

According to one advantageous characteristic, said fluid is dispensed during said sweeping step appreciably in parallel to said interface.

Thus, the sweeping fluid makes it possible not only to increase the speed at which the flocs rise in the flotation reactor, thus preventing re-flocculation, but also to release, from the surface of the gravity filter, those flocs that have nevertheless got deposited in it. Thus, the efficiency of the technique of the invention is even further improved.

In one advantageous embodiment, said step of sweeping and said step of backwashing are carried out simultaneously, thus even further increasing the speed at which the flocs rise and even further restricting the re-flocculation phenomenon.

According to a preferred aspect of the invention, a more efficient use is made of the volume of the wash water classically used for backwashing by distributing it appropriately between the bottom of the filter for the backwashing and the surface of the filter for sweeping the surface. In other words, the use of a step of sweeping according to the invention is preferably performed without the volume of water needed for the backwashing and the sweeping being appreciably greater than the volume of water that would be classically used for backwashing alone, when there is no sweeping.

According to one variant, said step of backwashing comprises a counterflow injection of water into said gravity filter at a speed of 8 to 60 m³/m²/h.

Thus, very great efficiency is obtained in the releasing of the flocs trapped in the gravity filter.

According to a preferred variant, said cycle for backwashing comprises the successive steps of counterflow injection of air into said gravity filter, counterflow injection of air and water into said gravity filter, counterflow injection of water into said gravity filter, said step of sweeping and said step for injecting water being implemented simultaneously.

Thus, the elimination of the flocs trapped in the gravity filter is favored. The efficiency of the washing is then improved.

According to one preferred embodiment, said cycle for treating comprises at least one step for mini-washing said gravity filter.

Carrying out mini-washing operations during a cycle for treating reduces the cavitation of the gravity filter. The frequency of the washing cycles can thus be increased, thus contributing, on the one hand, to increasing the production of treated water by increasing the duration of the cycles for treating and, on the other hand, to reducing the losses of water due to the washing of the filter.

In this case, said mini-washing step preferably comprises a counterflow infiltration of water into said gravity filter.

The duration of said step of infiltration is then preferably from 10 to 30 seconds, the water being infiltrated into said gravity filter at a speed advantageously ranging from 10 to 30 m/h.

Thus, an efficient reduction is obtained in gravity filter cavitation.

This mini-washing step can be improved by adding a simultaneous sweeping at the interface I during this mini-washing. This sweeping operation, in addition to chasing out air bubbles, breaks up the flocs to prevent a mattressing effect on the surface of the filter as soon as the filtering resumes following the mini-washing. The sweeping water is injected into the gravity filter preferably at a speed ranging of 8 to 20 m/h and advantageously for a duration of 10 to 30 seconds.

A method according to the invention preferably comprises a step for measuring a piece of information representing the head loss through said gravity filter, said step of mini-washing being activated when the measured value of said piece of information representing the head loss through said gravity filter is greater than or equal to a first predetermined threshold.

The mini-washing operations are then activated only when they really need to be implemented. Thus, the treatment of water is optimized.

The invention also pertains to an installation for treating water specially adapted to the implementing of a method according to any one of the variants mentioned here above.

Such an installation comprises:
means for intake of water to be treated;
a zone of coagulation followed or not followed by a zone of flocculation into which there lead said means for intake of water to be treated;
a flotation reactor comprising an inlet connected to the outlet of said coagulation and/or flocculation zone;
a gravity filter, said flotation reactor being at least partly superimposed on said gravity filter and communicating with it so that the water coming from said flotation reactor can flow gravitationally into said gravity filter;
   characterized in that said gravity filter has a bed of filtering material distributed on a height of 1.5 m to 3.0 m.

As indicated here above, such a height of filtering material makes it possible to implement high gravity filtering speeds ranging from 10 m/h to 30 m/h.

The filtering material could be monolayered or multilayered.

According to one variant said filtering material is constituted by a layer of sand having a grain size of 0.5 mm to 0.8 mm distributed on a height of 1.5 m to 3.0 m.

According to another variant, said filtering material is constituted by two layers, namely:
a lower layer of sand having a grain size of 0.5 mm to 0.8 mm distributed on a height of 0.75 m to 1.5 m and
an upper layer of a material having a grain size of 1.2 mm to 2.5 mm chosen from the group constituted by anthracite, pumice stone, filtralite® and granular activated carbon, distributed on a height of 0.75 m to 1.5 m.

According to yet another variant, said filtering material is constituted by three layers, namely:
a lower layer of a material chosen from the group constituted by manganese dioxide and garnet having a grain size of 0.2 mm to 2.5 mm, distributed on a height of 0.3 m to 2 m,
an intermediate layer of sand having a grain size of 0.5 mm to 0.8 mm, distributed on a height of 0.6 m to 3 m, and,
an upper layer of a material having a grain size of 1.2 mm to 2.5 mm chosen from the group constituted by anthracite, pumice stone, filtralite® and granular activated carbon, distributed on a height of 0.6 m to 3 m.

According to a preferred variant of the invention, the installation comprises, in addition, means for injecting a sweeping fluid into the interface between said flotation reactor and said gravity filter, said means for injecting comprising a system of bars for injecting a sweeping fluid that extend on the surface of said interface.

According to one particular embodiment, said bars comprise tubes perforated with orifices.

This technical solution makes it possible to carry out the step for sweeping simply but efficiently.

In this case the diameter of said orifices is from 30 to 40 millimeters.

The distance between two successive orifices made in a same perforated tube is from 100 to 150 millimeters.

The distance between two successive perforated tubes is from 1 to 2 meters.

When the surface area of the interface is greater than 36 m², the tubes are preferably spaced out by about 2 meters. For smaller-sized installations, they are preferably spaced out by about 1 to 1.5 meters.

The axes of said orifices essentially extend in parallel to said interface.

The sweeping fluid can thus be dispensed essentially in parallel to the interface between the flotation reactor and the gravity filter.

Said injection bars extend preferably in the sense of the width of said surface. The width of the flotation units is indeed most usually smaller than their length. Such a disposition of the bars for injecting sweeping water will thus create less head loss and will then induce a homogenous distribution of the water dispensed.

### 6. LIST OF FIGURES

Other features and advantages of the invention shall appear more clearly from the following description of a preferred embodiment, given by way of a simple illustratory and non-exhaustive example and from the appended figures, of which:

FIG. 1 illustrates a water treatment installation according to the prior art combining flotation and gravity filtering;

FIG. 2 illustrates a water treatment installation according to the invention;

FIG. 3 illustrates a view in perspective of the bars for injecting sweeping fluid of the installation of FIG. 2.

### 7. DESCRIPTION OF ONE EMBODIMENT OF THE INVENTION

### 7.1. Reminder of the General Principle of the Invention

The general principle of the invention relies on the implementing of high speeds of gravity filtering, above 10 m/h, in a technique for processing water combining flotation and gravity filtering through a bed of filtering material distributed on a height of 1.5 m to 3.0 m. This filtering is done preferably with a sweeping, during the washing of the gravity filter, of the interface between the flotation reactor and the gravity filter by a fluid dispensed by means of a system of injection bars that extend on the surface of said interface.

### 7.2. Example of an Installation According to the Invention

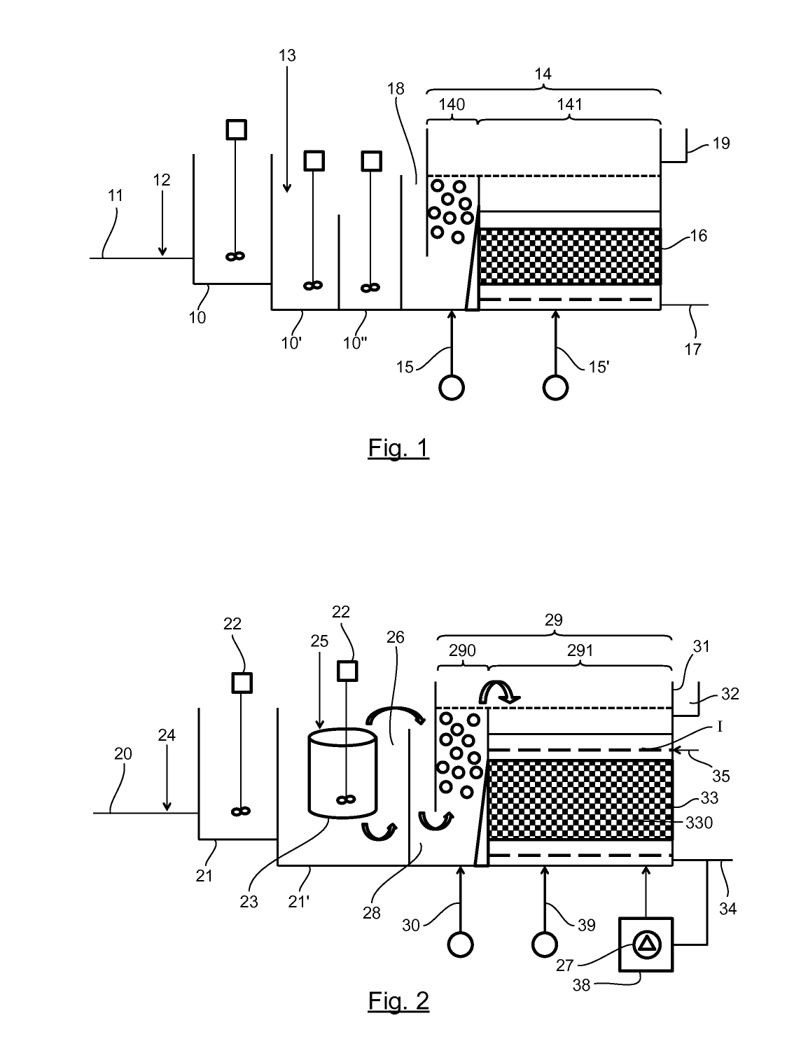

Referring to FIG. 2, we present an embodiment of a water treatment installation according to the invention.

Thus, as represented in FIG. 2, such an installation comprises a pipe 20 for the intake of water to be treated. This intake pipe 20 leads into a coagulation zone and then into a flocculation zone 20′ comprising one or preferably two tanks. The coagulation zone 21 and the flocculation zone 21′ house stirring means which, in this embodiment, comprise blade stirrers 22. Other stirring means could be implemented in variants. The flocculation zone 20′ herein also houses a flow-guiding element, also called a flow guide 23. In this embodiment, this flow guide 23 comprises a tubular element with a circular section within which the blade stirrer 22 is housed.

Means for injecting coagulant 24 lead, upstream to the coagulation zone 21, into the inlet pipe 20. In one variant, they could lead directly into the coagulation zone 21. Means for injecting flocculent 25 lead into the flocculation zone 21. The zone 21 in this embodiment therefore constitutes a coagulation zone and the zone 21′ constitutes a flocculation zone. In variants, the coagulation zone and the flocculation zone could be in the same tank. The flocculation zone 21′ can be sub-divided into several zones. Since the flocculation is optional, the installation could in some variants comprise no flocculation zone 21′.

The flocculation zone 21′ comprises an outlet 26 of coagulated and flocculated water situated at the top of the zone. As a variant, it could be situated at the bottom of this zone 21′. This outlet 26 is connected through an aperture 28 to the inlet of a flotation reactor 29 and more particularly the inlet of its mixing zone 290.

A pipe 30 for conveying oxygen-supersaturated water also leads into the inlet of the flotation reactor 29.

The flotation reactor 29 and more particular its separation zone 291 classically comprises an overflow element 31 which opens out into a chute 32 for discharging sludges constituted essentially by a mixture of air bubbles and sludge. It also comprises an underflow element, which communicates with the inlet of a gravity filter 33.

The gravity filter 33 extends in the prolongation of the flotation reactor 29, beneath it, and more particularly beneath its zone of separation from which the sludge is removed. The gravity filter 33 comprises a filtering mass 330.

This filtering mass 330 can be constituted by one or more layers of filtering material. The height of this filtering mass 330 is advantageously 1.5 to 3.0 meters and preferably equal to about 3 meters. It could also comprise:
a single layer of filtering material, for example constituted by sand or activated carbon, possibly with a grain size of 0.5 to 0.8 millimeters: this will be a monolayered filter;
an upper layer, for example of anthracite, pumice stone, filtralite or granular activated carbon, the grain size of which could range from 1.2 to 2.5 millimeters, and a lower layer, for example of sand, the grain size of which could range from 0.5 to 0.8 millimeters: this will be a two-layered filter;
an upper layer for example anthracite, pumice stone, filtralite or granular activated carbon, the grain size of which could range from 1.2 to 2.5 millimeters, an intermediate layer, for example of sand, the grain size of which could range from 0.5 to 0.8 millimeters and a lower layer, for example of manganese dioxide or garnet having a grain size of 0.2 to 2.5 millimeters: this is a three-layered filter.

In the two-layered filter, the height of the upper layer could be equal to that of the lower layer.

The gravity filter 33 comprises an outlet which leads into a pipe 34 for extracting treated water.

The installation comprises means for the intake of sweeping fluid 35. They comprise a pipe for the intake of a sweeping fluid 35 leading into a system of injection bars which extend to the surface of the interface I between the gravity filter 33 and the flotation reactor 29, especially its separation zone 291. The interface I is the upper surface of the gravity filter 33 and more specifically of its filtering mass 330.

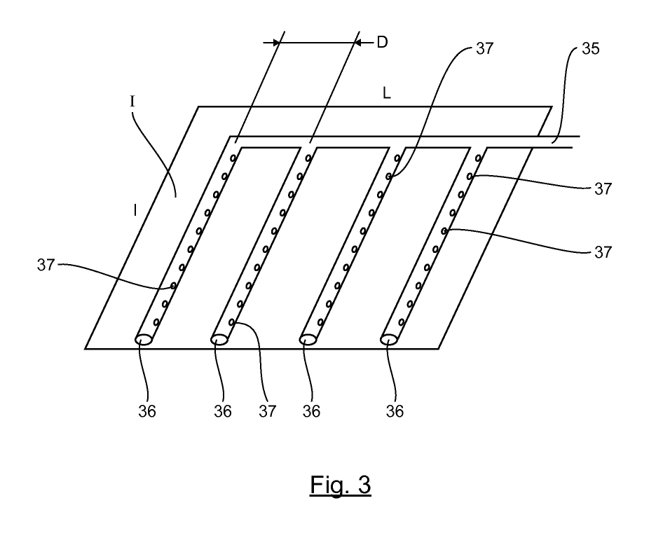

As shown in FIG. 3, which illustrates a magnified schematic view of the interface I between the gravity filter 33 and the flotation reactor 29, the injection bars comprise a plurality of tubes 36 which are connected to the intake pipe 35 of a sweeping fluid. The pipe 35 is a main pipe to which the tubes 36, which are associated pipes, are closely related.

The tubes 36 extend to the surface of the interface I, essentially in parallel to this interface. The distance D between two successive tubes 36 is preferably 1 to 2 meters. The tubes 36 extend in the direction of the width 1 of the interface I, the width 1 of this interface being smaller than its length L.

The tubes 36 are perforated with holes 37 which are made along axes essentially parallel to the surface of the interface I in order to prevent infiltrations of sand, particles or flocs. They are preferably placed above the filtering mass 330 at a height situated between 10 and 30 cm from them. The diameter of the orifices 37 is preferably 30 to 40 millimeters. The distance between two successive orifices 37 made on a same perforated tube 36 is preferably from 100 to 150 millimeters. The orifices 37 are calibrated to prevent head losses. They are preferably made at a rate of eight orifices per linear meter of tube 36. Because of such characteristics, a very homogenous distribution can be seen in the flow rate of water coming out of the holes.

The pipe 35 for intake of a sweeping fluid is connected, in this embodiment, to the pipe 20 for intake of water to be treated by means of a conduit on which a pump (not shown) is placed. In variants, it could be connected to the pipe 34 for extracting treated water by means of a conduit on which a pump not shown is placed or, as the case may be, to the pipe for extracting concentrate coming from a desalination unit, for example by reverse osmosis, placed downstream from the pipe for extracting treated water 34.

The installation comprises means for injecting air, comprising an air injection pipe 39 leading into the base of the gravity filter 33 and connected to means for producing air such as a compressor.

The installation comprises means for measuring a piece of information representing the head loss through the gravity filter 33. The head loss is thus measured by adapted instruments disposed upstream and downstream to the gravity filter.

The installation comprises means for backwashing the gravity filter 33. These backwashing means herein comprise a pump 27 used to send treated water, stored in a tub 38 via the extraction pipe 34, in a counterflow to the filter 33. In variants, they could include a pipe connected to the pipe 20 for intake of water to be treated, leading into the base of the gravity filter 33 and on which a pump to inject water to be treated in a counterflow into the filter. They could also for example include a pipe connected to a pipe for extracting concentrate from a reverse osmosis filtering unit placed downstream, leading into the base of the gravity filter 33 and on which a pump is mounted in order to inject desalination concentrate in a counter-flow into the filter.

The installation also comprises automatic driving means to control the activation of the cycles for treating and cycles for washing.

### 7.3. Example of a Method for Treating Water According to the Invention

A method for treating water according to the invention can consist for example in making water to be treated travel through an installation such as the one that has just been described.

During such a method, cycles for treating water and cycles for washing the gravity filter are implemented in alternation.

During a cycle for treating, the water to be treated is conveyed into the coagulation zone 21 via the intake pipe 20, for example by means of an intake pump.

One or more coagulant reagents are injected into the coagulation zone 21 and/or upstream from it via injection means 24. In this embodiment, one or more flocculent reagents are injected into the flocculation zone 21′. The stirrers 22 are made to work in such a way as to mix the coagulant and flocculent agents with the water to be treated. In this embodiment, the water to be treated then undergoes a step of coagulation and flocculation. However, the flocculation is optional and will not be implemented unless it is preceded by a step of coagulation. However, a coagulation step could be performed without being succeeded by any flocculation step.

The flow guide 23 is used to generate upward and downward flows of water within the flocculation zone as illustrated by the arrows. Its application therefore makes optimizes the stirring through the conversion of the radial flow into an axial flow. It also eliminates the dead spots and the bypasses. The mixture of coagulant and flocculent agents with water is thus improved. The contact time between the coagulant and flocculent agents can therefore be reduced, thus contributing to a reduction of about 25% in the volume and footprint of the coagulation zone 21 and, as the case may be, the flocculation zone 21′. This flow guide also reduces the stirring speed and eliminates the radial thrust, thus contributing to a reduction of the mechanical stresses on the stirring means. This technique is commercially distributed by the Applicant under the name Turbomix®.

The water thus coagulated and flocculated flows from the outlet 26 to the base of the flotation reactor 29 from its inlet 28. Oxygen-supersaturated water is injected into the input of this flotation reactor 29 via the pipe 30. The oxygen contained in this water expands and forms air bubbles within the flotation reactor 29. In this embodiment, the previoulsy coagulated and/or flocculated water and the oxygen-supersaturated water are injected in a co-current into the mixing zone 290. The previously coagulated and/or flocculated water then undergoes a flotation step inside the flotation reactor 29. During this flotation step, the flocs formed during the preliminary coagulation and/or flocculation step are trapped by the air bubbles, which rise to the surface of the flotation reactor 29. A mixture of flocs and air bubbles is then extracted in an overflow 31 from the flotation reactor 29 and discharged via the chute 32 by means of a scraping device (not shown) provided for this purpose.

In parallel with the flotation step the water, which is rid of most of the flocs that were initially in suspension therein, flows by gravity at a speed higher than 10 m/h and preferably of the order of 15 m/h in the gravity filter 33 through which it undergoes a step of gravity filtration. This high-filtering speed is possible because the height of the filtering mass 330 is great. During this step of gravity filtering, the water to be treated is rid of the rest of the flocs and other particles that were suspended therein. Depending on the nature of the filtering mass 330, a part of the organic pollution dissolved in the water to be treated can also be eliminated therefrom by adsorption.

The filtered water is extracted from the gravity filter 33 via the extraction pipe 34. It can then for example be conveyed to a zone for the storage of drinking water, for example a storage tub 38. If the water to be treated is saltwater, the water extracted from the filter 33 can serve as feedwater for desalination unit(s), for example reverse osmosis units, placed downstream.

As and when the water is filtered through the gravity filter 33, air bubbles gradually block the interstices left between the grains of the filtering mass 330, thus increasing the head loss through the gravity filter 33.

A step for measuring a piece of information representing the head loss through the gravity filter 33, such as for example the measurement of pressure upstream and downstream from the filter with the difference in these pressures reflecting this head loss, is preferably implemented continuously during the cycle for treating.

When the measured value of this piece of information representing the head loss through the gravity filter 33 is greater than or equal to a first predetermined threshold, a step of mini-washing is implemented.

This mini-washing step consists in infiltrating filtered water coming from the outlet of the gravity filter 33 via the pump 27 and the pipe 34, water to be treated and, as the case may be, reverse osmosis concentrate, in a counter-flow in the gravity filter 33 according to a speed preferably ranging from 10 to 30 m/h. The duration of the mini-washing is preferably 10 to 30 seconds. Mini-washes could thus be implemented for example every six hours.

During these mini-washes, the air bubbles trapped within the gravity filter 33 are discharged from it. Thus, gas cavitation of the gravity filter is restricted. The frequency of the washing cycles of the filters can thus be lengthened and water losses can be reduced. Consequently, the duration of the cycles for treating as well as the quantity of treated water produced are increased.

As and when the water is filtered through the gravity filter 33, the interstices between the grains that form its filtering mass 330 are gradually clogged by the material which had been initially in suspension in it.

When the measured value of a piece of information representing the head loss through the gravity filter 33 becomes greater than or equal to a second predetermined threshold, that cycle for treating is stopped and the cycle for washing the gravity filter 33 is initiated.

In this embodiment, the cycle for treating comprises a first sub-step for discharging all the sludges, i.e. the mixture of air bubbles and flocs, present in an overflow element 31 of the flotation reactor 29 via the chute 32.

The next sub-step consists in stopping the arrival of raw water to be treated in the treatment installation.

During the next sub-step, the water contained in the flotation reactor 29 is filtered through the gravity filter 33 until the level of water in the flotation reactor 29 is zero, i.e. until it is at the interface I, in other words the upper face of the filtering mass 330.

In the next sub-step, the gravity filter is aerated in a counter-flow for a duration of one to three minutes at a flow rate of 35 Nm³/m²/h to 60 Nm³/m²/h. This is done by introducing air therein via the pipe 39. The filtering mass is thus destabilized, the effect of which is release the flocs that are clinging to it.

In the next sub-step, the aeration of the gravity filter 33 is continued and wash water is injected therein in a counter-flow via the pipe 34 at a speed ranging preferably from 8 m/h to 12 m/h for five to 10 minutes. The filtering mass 330 is then put into suspension and the flocs become free to be discharged.

In the next sub-step, the aeration of the gravity filter 33 is stopped.

During the next sub-step, wash water also called rinsing water in this step is injected in a counter-flow at high speed, preferably 15 to 60 m/h, into the gravity filter 33 via the pipe 34 for 5 to 15 minutes. The flocs contained in the gravity filter 33 can thus be discharged out of the installation in flowing through a channel provided for this purpose as an overflow element 31 of the flotation reactor 29.

Simultaneously, the sweeping water is dispensed on the surface of the interface I via the perforated tube 36 substantially in parallel to it for a period preferably ranging from 5 to 15 minutes, the wash water being injected into the gravity filter at a speed preferably ranging from 8 m/h to 20 m/h.

Thus, a horizontal sweeping current is created on the surface of the interstices I. The speed at which the sludges rise in the flotation reactor 29 is thus increased, thus making it possible to avoid or at any rate to limit the re-flocculation process. It will be noted that this sweeping is done without appreciably increasing the quantity of water relative to the quantity of backwash water that would be necessary in its absence.

The end of the washing cycle is determined by a clock signal or on the quantity of water overflowing from the flotation unit at the end of washing, ascertained by a measurement of turbidity. Or again it is determined on the basis of a total volume of water accounted for during the washing. At the end of the cycle for washing, a new cycle for treating is performed. A plurality cycles for treating and washing cycles for washing is thus carried out in alternation.

1-22. (canceled)

23. A method for treating water in order to make it drinkable or desalinated, said method comprising at least one cycle for treating said water comprising:
a step of coagulation;
a step of flotation, within a flotation reactor, of the water coming from said step of coagulation;
a step of gravity filtration, within a gravity filter, of the water coming from said step of flotation, said flotation reactor being at least partly superimposed on said gravity filter, and at least one cycle for washing said gravity filter comprising a step for backwashing said gravity filter,
characterized in that said step of gravity filtration is carried out at a speed of 10 m/h to 30 m/h, said gravity filter having a bed of filtering material distributed over a height of 1.5 m to 3.0 m.

24. The method according to claim 23 characterized in that said cycle for washing comprises a step for sweeping an interface between said flotation reactor and said gravity filter with a fluid dispensed by a system of injection bars that extend on the surface of said interface.

25. The method according to claim 24 characterized in that, during said step of sweeping, said fluid is dispensed substantially in parallel to said interface.

26. The method according to claim 24, characterized in that said step of sweeping and said step of backwashing are carried out simultaneously.

27. The method according to claim 23, characterized in that said step of backwashing comprises a counterflow injection of water into said gravity filter at a speed of 8 to 60 m³/m²/h.

28. The method according to claim 24, characterized in that said cycle for backwashing comprises successive steps of counterflow injection of air into said gravity filter, counterflow injection of air and water into said gravity filter, counterflow injection of water into said gravity filter (33), and said step of sweeping and said step for injecting water being implemented simultaneously.

29. The method according to claim 23, characterized in that said cycle for treating comprises at least one step for mini-washing said gravity filter.

30. The method according to claim 29, characterized in that said step of mini-washing comprises a counterflow infiltration of water into said gravity filter.

31. The method according to claim 30, characterized in that the duration of said step of infiltration is from 10 to 30 seconds, the water being infiltrated into said gravity filter at a speed of 10 to 30 m/h.

32. The method according to claim 29, characterized in that said step of mini-washing comprises a step for sweeping said interface.

33. The method according to claim 29, characterized in that the method comprises a step for measuring a piece of information representing the head loss through said gravity filter, said step of mini-washing being activated when the measured value of said piece of information representing the head loss through said gravity filter is greater than or equal to a first predetermined threshold.

34. An installation for treating water adapted to the implementing of a method according to claim 1, characterized in that it comprises:
means for intake of water to be treated;
a zone of coagulation;
a flotation reactor comprising an inlet connected to an outlet of said coagulation zone;
a gravity filter;
said flotation reactor being at least partly superimposed on said gravity filter and communicating with it so that the water coming from said flotation reactor flows gravitationally into said gravity filter; and
characterized in that said gravity filter has a bed of filtering material distributed over a height of 1.5 m to 3.0 m.

35. The installation according to claim 34 characterized in that said filtering material is constituted by a layer of sand having a grain size of 0.5 mm to 0.8 mm distributed over the height of 1.5 m to 3.0 m.

36. The installation according to claim 34 characterized in that said filtering material is constituted by two layers, namely:
a lower layer of sand having a grain size of 0.5 mm to 0.8 mm distributed over a height of 0.75 m to 1.5 m; and
an upper layer of a material having a grain size of 1.2 mm to 2.5 mm chosen from the group comprising anthracite, pumice stone, filtralite and granular activated carbon, distributed over a height of 0.75 m to 1.5 m.

37. The installation according to claim 34 characterized in that said filtering material is constituted by three layers, namely:
a lower layer of a material chosen from the group comprising manganese dioxide and garnet having a grain size of 0.2 mm to 2.5 mm, distributed over a height of 0.3 m to 2 m,
an intermediate layer of sand having a grain size of 0.5 mm to 0.8 mm, distributed on a height of 0.6 m to 3 m, and,
an upper layer of a material having a grain size of 1.2 mm to 2.5 mm chosen from the group comprising anthracite, pumice stone, filtralite and granular activated carbon, distributed on a height of 0.6 m to 3 m.

38. The installation according to claim 34 characterized in that it comprises means for injecting a sweeping fluid into the interface between said flotation reactor and said gravity filter, said means for injecting comprising a system of bars for injecting a sweeping fluid that extend on the surface of said interface.

39. The installation according to claim 38, characterized in that said bars comprise tubes perforated by orifices.

40. The installation according to claim 39, characterized in that the diameter of said orifices is from 30 to 40 millimeters.

41. The installation according to claim 39, characterized in that the distance between two successive orifices made in a perforated tube is from 100 to 150 millimeters.

42. The installation according to claim 39, characterized in that the distance between two successive perforated tubes is from 1 to 2 meters.

43. The installation according to claim 39, characterized in that the axes of said orifices extend essentially in parallel to said interface.

44. A method of treating water comprising:
mixing a coagulant with the water;
after mixing the coagulant with the water, directing the water into a flotation reactor by directing the water over a flow guide and downwardly into a base portin of the flotation reactor and upwardly therefrom into an upper disposed zone in the flotation reactor;
injecting oxygen-saturated water into a lower portion of the flotation reactor where the oxygen-saturated water forms air bubbles;
directing the water, oxygen-saturated water and bubbles concurrently upwardly through a portion of the flotation reactor to an upper portion thereof;
forming floc in the flotation reactor and employing the air bubbles to move the floc to the surface of the water contained in the flotation reactor;
extracting a mixture of floc and air bubbles from the flotation reactor;
filtering the water downwardly through a gravity filter disposed beneath a portion of the flocculation reactor at a speed of at least 10 m/h and filtering the water to remove floc and suspended solids and to produce filtered water;
extracting the filtered water from the gravity filter;
measuring the head loss of the gravity filter and when the head loss exceeds a selected threshold value, backwashing the gravity filter;
aerating the gravity filter by injecting compressed gas into the lower portion of the gravity filter and causing the compressed gas to move upwardly through the gravity filter and causing floc trapped in the gravity filter to be dislodged; and
injecting sweeping water generally through an interface between the flotation reactor and the gravity filter and causing a horizontal current of sweeping water to flow horizontally between the flotation reactor and the gravity filter.

45. The method of claim 44 wherein the gravity filter includes a bed of filtering material that is distributed over a height of approximately 1.5 m to approximately 3.0 m and wherein the method includes directing water from the flotation reactor downwardly through the bed of filtering material in the gravity filter.

46. The method of claim 45 wherein the sweeping water is dispensed from a system of injection bars that are disposed between the flotation reactor and the gravity filter.
